(19) United States
(12) Patent Application Publication
(10) Pub. No.: US 2009/0184968 A1
(43) Pub. Date: Jul. 23, 2009

(54) Incentive Method For The Spirometry Test With Universal Control System Regardless Of Any Chosen Stimulating Image

(75) Inventor: Paolo Boschetti Sacco, Rome (IT)

Correspondence Address: YOUNG & THOMPSON, 209 Madison Street, Suite 500, ALEXANDRIA, VA, 22314, US

(73) Assignee: MIR SRL MEDICAL INTERNATIONAL RESEARCH, Rome (IT)

(21) Appl. No.: 12/298,625

(22) PCT Filed: Apr. 26, 2006
(86) PCT No.: PCT/IT2006/000285

§ 371 Date: Oct. 27, 2008

(51) Int. Cl. G06T 15/70

(52) U.S. Cl. 345/473

(57) ABSTRACT

An incentive method for the spirometry test wherein the use of two separate images instead of only one is provided, the first image being controlled by the incentive control mechanism related to respiration of the patient, and the second image, initially covered by the first image, representing the incentive to the spirometry and being completely independent both of the first image and the respiration. The first image is universal in the meaning that it can be used from time to time with a virtually infinite number of second incentive images. The first image is modified as the spirometry test proceeds to unveil gradually the second image which is an image having a meaning only if completely unveiled, the incentive effect being then the motivation to blow so that the curtain unveils completely an image which has its completeness and can be interpreted only if completely unveiled.

Spirometry is a diagnostic test providing the analysis of the respiratory functionality.

The test is carried out by blowing to a spirometer and the correct execution thereof always requires the maximum collaboration of the patient as the result of the test depends on the capability of the patient to breathe out all air of lungs at the maximum possible speed.

If these conditions are not fulfilled, the result of the spirometry is considered not reliable or, as usual in the jargon of physicians, “not acceptable”.

The execution of the test can be very difficult for children, elders, handicapped patients or people with psychological troubles.

Therefore, some manufacturers of diagnosis apparatus thought recently to help such measurements by producing incentive systems for the spirometry test which have, however, use and effectiveness limitations.

By way of example, already existing apparatus show the imagine of a child blowing to the candles on a pie one at a time as the expiration proceeds or a child blowing into a balloon until it burst.

Such systems are conceived so that every stimulating imagine corresponds to a cartoon control which is firmly related both to the respiration and the imagine itself. Of course, this prevents the imagine from being replaced by another imagine.

It is clear that in this case the software relating the incentive to the respiration is adapted only to a determined animation and if it is desired to replace the latter with another animation, it is necessary for the control to fit the new one.

It is self-evident that one drawback of the current spirometry incentive systems is the quite limited offer of imagines or animations made available by the manufacturer of the spirometer.

The main object of the present invention is to overcome the problems of the current spirometry incentive systems by providing a novel incentive control method in which the mechanism relating the cartoon to the respiration is only one and universal, and can be used with a virtually infinite number of incentive imagines.

This has been accomplished according to the invention by providing a method using two imagines instead of only one: the first imagine is controlled by the incentive control mechanism related to respiration, and the second imagine represents the incentive to the spirometry and is completely independent both of the first imagine and the respiration. The first imagine is universal in the meaning that the new method is adapted to use a virtually infinite number of second incentive imagines.

A better understanding of the invention will result from the following detailed description with reference to the accompanying drawings that show a preferred embodiment thereof only by way of a not limiting example.

In the drawings:

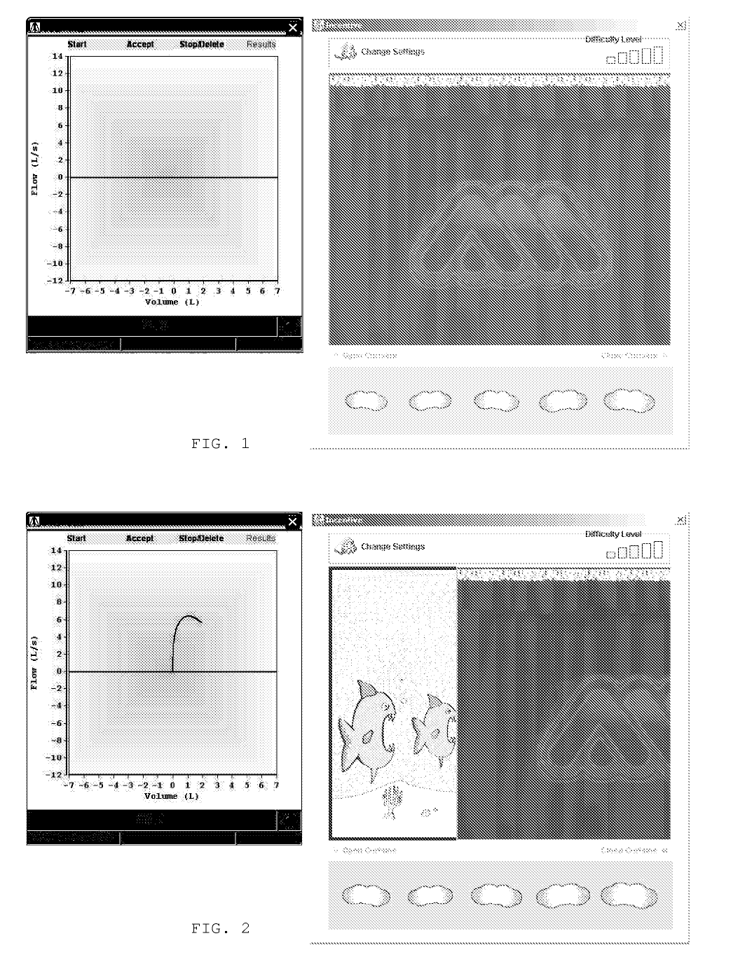

FIG. 1 shows the incentive imagine in the case of a curtain moving sideways and the relative spirometry diagram before the test;

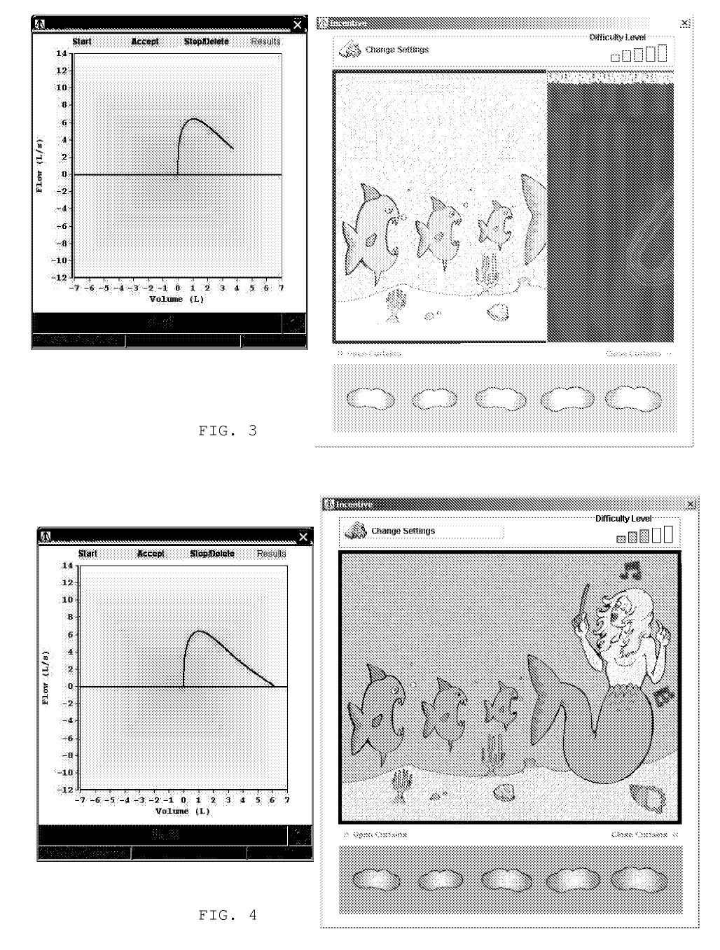

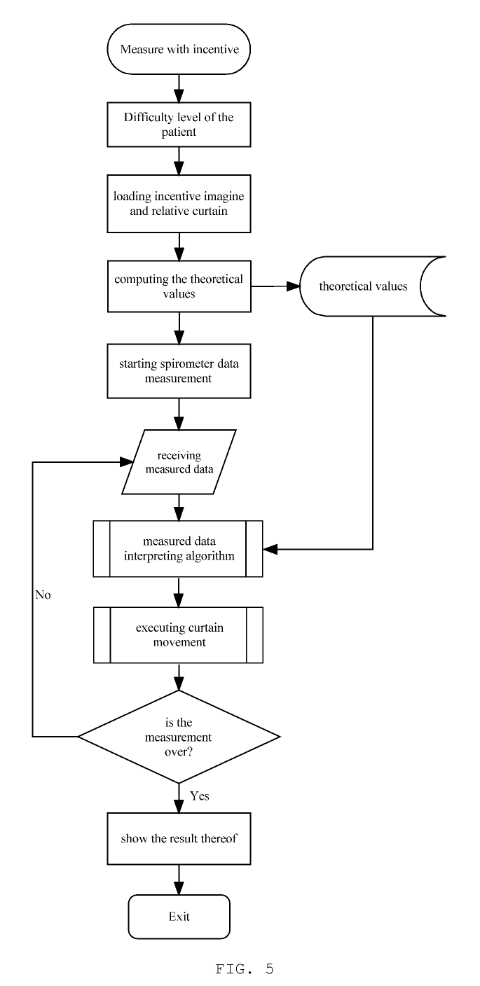

FIGS. 2, 3 and 4 similar to FIG. 1 relates to the initial and final steps and after the test; and

FIG. 5 is a flow chart of the method according to the invention.

As already mentioned above, the existing technology is mainly directed to children so that the incentive systems on the market are exclusively for children's use.

The establishment at the basis of such systems is that children bored, as well-known, by a test carried out in a medical environment can be easily motivated conversely by imagines stimulating them and suitably related to the respiration.

Therefore, incentives based upon the psychological mechanism of waiting for an event and translated into imagines related to the test and having an incentive effect have been developed.

The hitherto used technology has the following limits:
the incentive provides not only the imagine but also the relative cartoon control software;
every incentive option has its software and its development cost;
the software required for every incentive limits necessarily the number thereof produced by the manufacturer and is a strong limitation to the development of new incentives by the physician (or anybody taking care of the patient);
the limited number of available incentives is destined a priori to determined patients to whom they are referred;
because of their simple imagines, the children's incentives that can be found on the market do not have effect to other patients (e.g. elders) that even would need them;
at last, the greatest limitation among those listed above is that the incentive effect of the system using cartoons is very limited in time with respect to the patient subjected to several spirometry tests. Actually, after one display (e.g. after having blown out one candle on the pie) the surprise effect vanishes as the conclusion is already known;
considering the limited number of available displays, the conventional incentive systems show the limits of being not effective to the same patient any longer after the latter has understood the mechanism.

### OPERATION OF THE NEW INCENTIVE SYSTEM

One peculiar feature of the present invention is the “architecture” of the incentive based upon the progressive opening of a curtain (or other alternative mechanism) related to the spirometry test. The curtain in turn hides an imagine (or animation) which is completely released from and independent of the curtain. The curtain moves as the spirometry test proceeds and unveils gradually the imagine of the “path”, i.e. an imagine having a meaning only if completely unveiled. The incentive effect is then the motivation to blow so that the curtain unveils completely an imagine which has its completeness and can be interpreted only if completely unveiled (FIGS. 1 to 4).

Upon carrying out the spirometry test the help of the incentive program is an available option. If the physician opts for it, he/she can further choose between a list of available proposals (fixed or animated imagines) or can import an imagine file he/she likes.

Actually, the incentive can be very easily personalised by any imagine provided that a meaning is given which is incomplete in its first few strokes or however rouses the patient's curiosity to see the whole scene.

Both stationary and dynamic (cartoon) incentives can be used and a series of both types is provided.

The activation of the incentive can either be controlled from time to time or automatically according to the age of the patient.

At last, the incentive system can be used both with a PC connected to the spirometer and directly with the spirometer, of course keeping into account the different memory size and display quality in both cases.

Another peculiar feature of the invention is its calculation algorithm based upon volume and flow rate increments (speed of the expired air) with respect to the “theoretical value” so-called also “awaited value” or “nominal value” of the patient.

The movement of the curtain derives from the combination of these two parameters compared with the theoretical value. Owing to this exclusive algorithm the system is “protected” against non-significant test, for example as the patient blows slowly instead of blowing with the maximum energy.

Furthermore, it is possible to change the level of difficulty to reach the object (correct diagnostic test) by adjusting the “resistance” of the curtain upon opening. This feature makes the incentive very flexible and adapted to several categories of patients.

### ADVANTAGES AND BENEFITS OF THE INVENTION

One advantage of the present invention comes from the new idea of providing an incentive control mechanism which is completely independent of the incentive imagine which makes it unique and universal, i.e. able to control a virtually infinite number of incentive imagines.

Such mechanism based upon two independent imagines consists, as already mentioned, of the movement of a curtain (similar to the curtain of a theatre) the running of which is controlled via software by means of an algorithm which keeps into account volume and flow rate of the expired air.

The user can put a practically unlimited number of imagines/cartoons under or, if preferred, behind the curtain in addition to those predefined by the manufacturer without any cost.

The sole feature of the imagine/cartoon causing the incentive effect is the presence of a “stimulation event” which is unveiled in the end by inducing psychologically the patient to the whole sight. It is easy to understand how any picture or imagine downloaded from Internet or CD/DVD, or any digital or scanned picture can be used and easily replaced at every spirometry test.

A considerable flexibility and cheapness of use of the mechanism is then reached so that the latter is adapted to a lot of situations as well as keeps always effective and stimulating even if used several times by the same patient.

According to the invention, the sliding of the curtain can take place to the horizontal direction from left to right or vice versa or to the vertical direction from top to bottom and vice versa. For example, the animation of a dropping parachute or a rising balloon (or kite) could be looked at.

Any imagine dear to a child could be used, for example, an imagine drawn out of a family album or a cartoon, or a drawing made by the same child which can be easily imported.

According to the present invention an incentive system can be provided which is:
based upon a control system independent of the incentive imagine;
operating together with a mechanism related to the respiration and able to control the progressive display of the imagine;
adapted not only to spirometry test but also to any diagnostic test supported by imagines or animations, the result of which is related to the patient's collaboration;
able to give the display effect by several progressive display systems (curtain, drop-curtain, fading, sliding doors, photographic diaphragm, bellow, shutter, strips, a.s.o.);
supporting mechanism of moving imagines to all possible directions (from top to bottom, from bottom to top, from left to right, from right to left, oblique), and fading;
operating with any incentive imagine;
able to change the incentive imagine easily and without additional cost;
adapted to different categories of patients;
not requiring expenses and investments to cover the several categories of patients;
able to grade the difficulties of the incentive for any patient;
able to relate the incentive both to volume and flow rate of the expired air;
able to allow a high number of complete, reliable tests from the diagnostic point of view;
able to help the patient to understand any mistake made during the spirometry and to keep the motivation of the patient high;
able to allow a virtually infinite number of test with the same patient keeping the incentive effectiveness unchanged and without additional cost and investments;
ideal for patient that are unresponsive to spirometry by the conventional systems because of the personalization of the incentive imagine;
able to optimise the productivity of the medical staff as well as the number of acceptable spirometries carried out during a determined period of time.

At last, with particular reference to FIG. 5, the method disclosed above includes the following steps:
1. input of the difficulty level of the patient;
2. loading incentive imagine and relative curtain;
3. computing the theoretical values;
4. starting spirometer data measurement;
5. receiving measured data;
6. interpreting measured data and comparing them with theoretical data;
7. moving curtain according to the interpretation;
8. is the spirometry over? then show the result thereof, otherwise go back to step 5;
9. ending process after showing the result.

According to the invention, the spirometry test in term of volume and flow rate of the air expired by the patient can also be displayed on a diagram, as shown in FIGS. 1 to 4.

It should be appreciated that upon keeping the inventive concept of the present invention unchanged, a “thick fog” or a “thick smokescreen” which is blown away by the patient during the spirometry test can also be provided as an alternative to the moving curtain.

The present invention has been described and illustrated according to a preferred embodiment thereof, however, it should be understood that those skilled in the art can make technically and functionally equivalent modifications and/or replacements without departing from the scope of the present industrial invention.

1-13. (canceled)

14. An incentive method for the spirometry test providing the use of two images instead of only one, characterized in that the first image is controlled by the incentive control mechanism related to respiration of the patient, and in that the second image, initially covered by said first image, represents the incentive to the spirometry and is completely independent from both of the first image and the respiration, the first image being suitable to be used with whatever kind of second incentive images.

15. The method according to claim 14, characterized in that said first image is modified as the spirometry test proceeds to unveil gradually the second image which is an image having a meaning only if completely unveiled, the incentive effect being then the motivation to blow so that the curtain unveils completely an image which has its completeness and can be interpreted only if completely unveiled.

16. The method according to claim 15, characterized in that the incentive action of the first image is based upon the progressive opening of a curtain or the progressive thinning out of smoke or fog or another similar means related and subordinated to the spirometry test.

17. The method according to claim 15, characterized in that the second image can be personalised for any patient so that a meaning is initially provided which is incomplete or however rouses the patient's curiosity to see the whole scene.

18. The method according to claim 16, characterized in that the second image can be personalised for any patient so that a meaning is initially provided which is incomplete or however rouses the patient's curiosity to see the whole scene.

19. The method according to claim 17, characterized in that there is provided a calculation algorithm based upon volume and flow rate increments (speed of the expired air) with respect to the theoretical value of the patient.

20. The method according to claim 19, characterized in that said algorithm allows the level of difficulty to be changed in order to carry out a correct diagnostic test by adjusting the effort made by the patient to unveil the second image hidden under the first one so that the incentive is very flexible and adapted to several categories of patients.

21. The method according to claim 16, characterized in that the sliding of the curtain takes place to the horizontal direction from left to right or vice versa or to the vertical direction from top to bottom and vice versa.

22. The method according to claim 14, characterized by the following steps:
A. input of the difficulty level of the patient;
B. loading incentive image and relative curtain;
C. computing the theoretical values;
D. starting spirometer data measurement;
E. receiving measured data;
F. interpreting measured data and comparing them with theoretical data;
G. moving curtain according to the interpretation;
H. is the spirometry over? then show the result thereof, otherwise go back to step E;
I. ending process after showing the result.

23. The method according to claim 22, characterized in that the spirometry test in term of volume and flow rate of the air expired by the patient can also be displayed on a diagram.

24. The method according to claim 14, characterized in that said second image is stationary or moving (animated).

25. A spirometer, characterized in that it is provided with an incentive system according to the method of claim 14.

26. An electronic processor or PC connected to a spirometer, characterized in that it is provided with an incentive system according to the method of claim 14.
